(19) United States
(12) Patent Application Publication
(10) Pub. No.: US 2002/0126485 A1
(43) Pub. Date: Sep. 12, 2002

(54) Positioning frame of a hanging light bulb string

(76) Inventor: Wun Fang Pan, Hsinchu (TW)

Correspondence Address: Morton J. Rosenberg, Esq., Rosenberg, Klein & Lee, Suite 101, 3458 Ellicott Center Drive, Ellicott City, MD, 21043, US

(21) Appl. No.: 09/803,096

(22) Filed: Mar. 12, 2001

(51) Int. Cl. F21S 13/14

(52) U.S. Cl. 362/252; 362/249; 362/806

(57) ABSTRACT

The present invention relates to a positioning frame of a hanging light bulb string, which provides a positioning frame being capable of being folded and having several parallel rigid ribs for connecting with the branch string thereon in position without being winded. It can keeps the hanging light bulb string in a perfect decorative display and it can store the whole string in order by folding the two nearby frames and facilitates to be extended when it is reused to obtain the original especial lighting effect.

### BACKGROUND OF THE INVENTION

A known hanging light bulb string is usually including a long bulb string or several parallel short bulb strings being connected to become a curved-type hanging string. Each branch string is hanging naturally and may be winded with each other possibly in use. So the main decorative purpose can not be maintained and the lighting effect is also lost. Most of all, the known structure will be very difficult to be reused after storage. The branch string of the hanging light bulb string will be totally disturbed.

Accordingly, the primary object of the invention is to provide a positioning frame of a hanging light bulb string, which provides a positioning frame with arched ribs to keep the branch string in a related place and to maintain a perfect decorative curved-type hanging string. Now the features and advantages of the present invention will be described in detail with reference to the accompanying drawings.

### BRIEF DESCRIPTION OF ACCOMPANYING DRAWINGS

FIG. 1 is a plan exemplary view showing a hanging light bulb string according to the present invention.

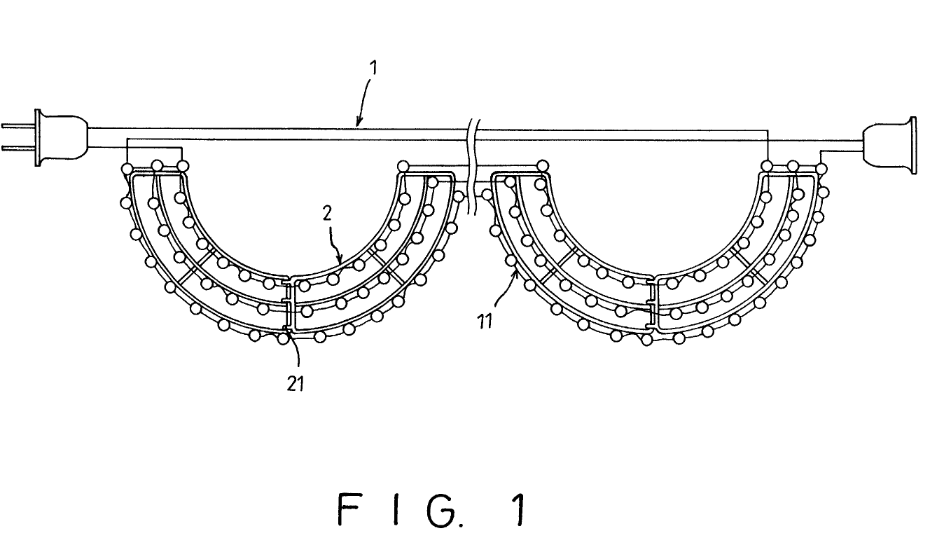

FIG. 2 is a perspective view of a positioning frame according to the present invention.

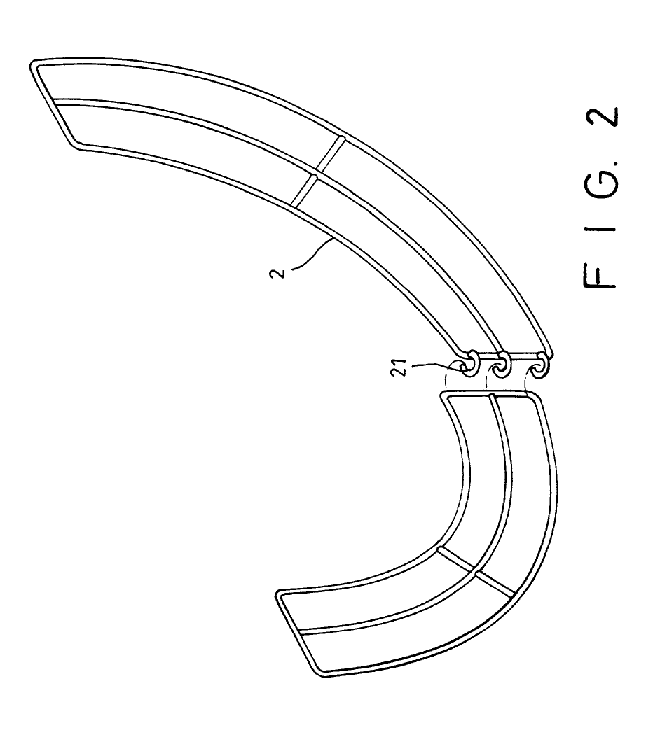

FIG. 3 is an assembled view of FIG. 2 connected with a branch string according to the present invention.

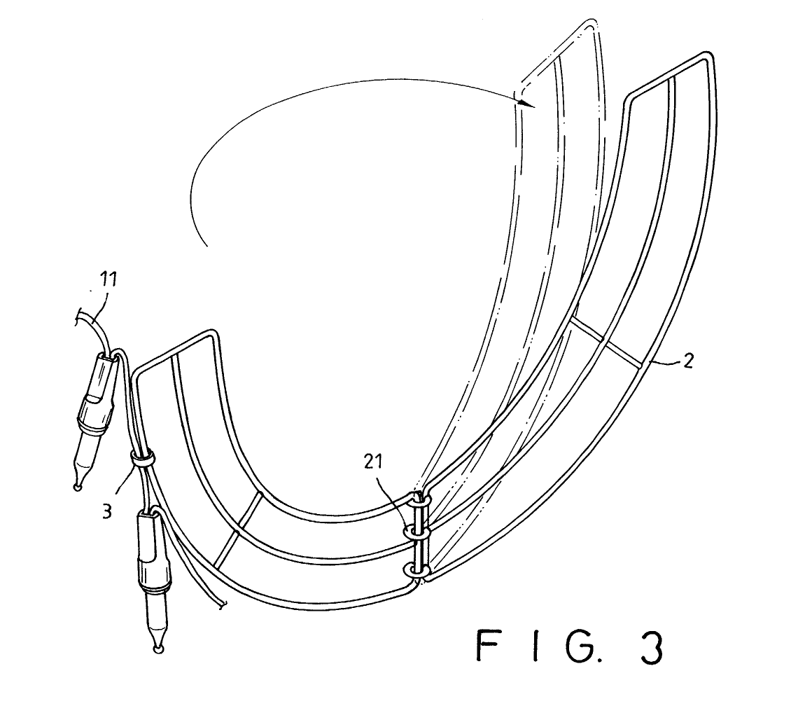

FIG. 4 is a plan view of FIG. 2 being connected and being folded according to the present invention.

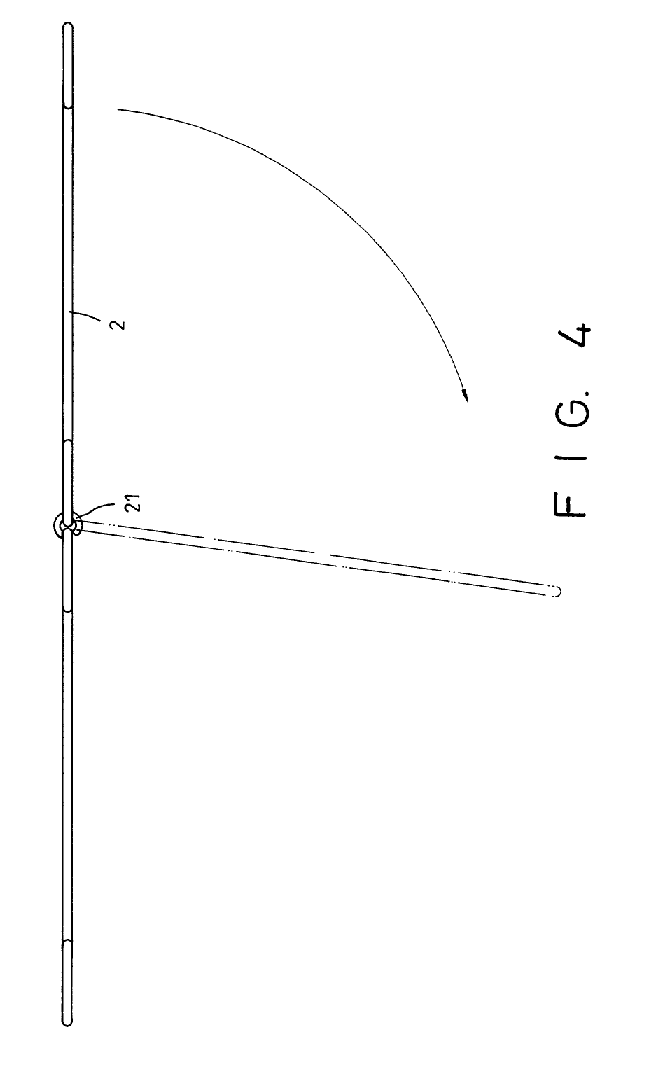

### DETAILED DESCRIPTION OF PREFERRED EMBODIMENTS

Referring to the figures, the present invention relates to a positioning frame of a hanging light bulb string, which includes a frame (2) having several parallel arched ribs and several end hooks (21) for connecting with a related frame (2). The two frames (2) are therefore capable of being folded to become overlapped. The hanging light bulb string has a main electrical wire (1) with a branch string (11). The branch string (11) can be fixed on the arched rib of the frame in position by winding itself around the rib or by any suitable loop (3).

Under the aforesaid assembly, the present invention can provide a stable decorative outlook to keep the branch string being connected on the arched rib of the frame that obtains a perfect lighting effect. When it is to be stored, each set of two frames can be folded easily and the branch string will never be winded or disturbed. It will be very convenient to be reused this hanging light bulb string by just extending the frame to obtain the original curved-type decoration.

As above mentioned, it is only an exemplary according to the present invention. Other simple modification will be claimed in this invention, such as to increase the number of the rib of the frame or modified the connecting hook for engaging the nearby frame.

What is claimed is:

1. A positioning frame of a hanging light bulb string including a positioning frame with several parallel arched ribs for connecting with the branch string thereon to obtain a curved-type decorative effect in secure position, wherein the frame is capable of being hooked with a nearby frame, both of which can be folded to be overlapped.

2. The positioning frame of a hanging light bulb string as claimed in claim 1, wherein the number of the rib of the frame is more than two.

3. The positioning frame of a hanging light bulb string as claimed in claim 1, wherein the frame is provided with several hooks for connecting the nearby frame.

4. The positioning frame of a hanging light bulb string as claimed in claim 1, wherein the branch string is fixed on the rib of the frame by winding itself around the rib or by any suitable connecting loops.
